(19) United States
(12) Patent Application Publication
(10) Pub. No.: US 2005/0060291 A1
(43) Pub. Date: Mar. 17, 2005

(54) Method and apparatus for searching universal resource identifiers

(75) Inventors: Dustin C. Kirkland, Austin, TX (US); Liliana Orozco, Del Valle, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/660,013

(22) Filed: Sep. 11, 2003

(51) Int. Cl. G06F 17/30; G06F 17/00; G06F 7/00

(52) U.S. Cl. 707/3; 707/10; 707/4; 707/5; 707/104.1

(57) ABSTRACT

A method, apparatus, and computer instructions to search for Web pages within a Web site. A search statement is received as a result of a user input in which the search statement includes a universal resource identifier and a regular expression. A set of universal resource identifiers associated with the universal resource identifier in the request are retrieved to form a set of retrieved universal resource identifiers. These retrieved identifiers are parsed using the regular expression to form search results. The search results are returned in which the search results include a list of universal resource identifiers associated with Web pages for the Web site.

### BACKGROUND OF THE INVENTION

1. Technical Field

The present invention relates generally to an improved data processing system and in particular to a method and apparatus for searching data. Still more particularly, the present invention relates to a method, apparatus, and computer program for searching for documents using universal resource identifiers.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a universal resource identifier (URI) in the form of Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Presently, users may employ search engines to search for Web pages on different Web sites. These search engines employ a keyword search process in which keywords are entered by a user. These keywords are used to search for different Web pages that may be located across different sites. Results are returned as a set of links that may be selected by the user. Additionally, Web sites themselves often provide searching capabilities to search for content within the Web site. These searches focus on allowing the user to search for keywords that are in the Web page. When searching for text or information on a Web site, the user currently must enter the site itself. After entering the Web site, a “search” option is selected. A search query is entered into the field provided and the search is activated or initiated by selecting or pressing a search button. Such a search process requires a number of steps and time.

For example, entering a Web site often is not immediate and takes some amount of time, depending on the graphics and other features provided. A significant amount of time may pass before the Web site is entered, especially if the user is accessing the Internet through a dial-up connection. After entering the Web site, the user must find the page or enter search queries when a search option is found for the Web site. These additional steps also take time. Most users on the Web are impatient and do not like to wait for content to download for presentation. The amount of time and number of steps may frustrate users exploring the Web. Additionally, even if the user is accessing Web sites through a broadband connection, traffic at the Web site or on nodes between the user and the Web site also may cause delays.

Therefore, it would be advantageous to have an improved method, apparatus, and computer instructions for searching a Web site.

### SUMMARY OF THE INVENTION

The present invention provides a method, apparatus, and computer instructions to search for Web pages within a Web site. A search statement is received as a result of a user input in which the search statement includes a universal resource identifier and a regular expression. A set of universal resource identifiers associated with the universal resource identifier in the request are retrieved to form a set of retrieved universal resource identifiers. These retrieved identifiers are parsed using the regular expression to form search results. The search results are returned in which the search results include a list of universal resource identifiers associated with Web pages for the Web site.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are diagrams illustrating components used in providing a URI search system in accordance with a preferred embodiment of the present invention;

FIG. 5 is an example of a command or request in accordance with a preferred embodiment of the present invention;

FIG. 6 is a diagram of a table of contents in accordance with a preferred embodiment of the present invention;

FIG. 7 is a flowchart of a process for searching for Web pages in accordance with a preferred embodiment of the present invention; and

FIG. 8 is a flowchart of a process for processing a request to search for universal resource identifier in accordance with a preferred embodiment of the present invention.

### DETAILED DESCRIPTION OF THE PREFERRED EMBODIMENT

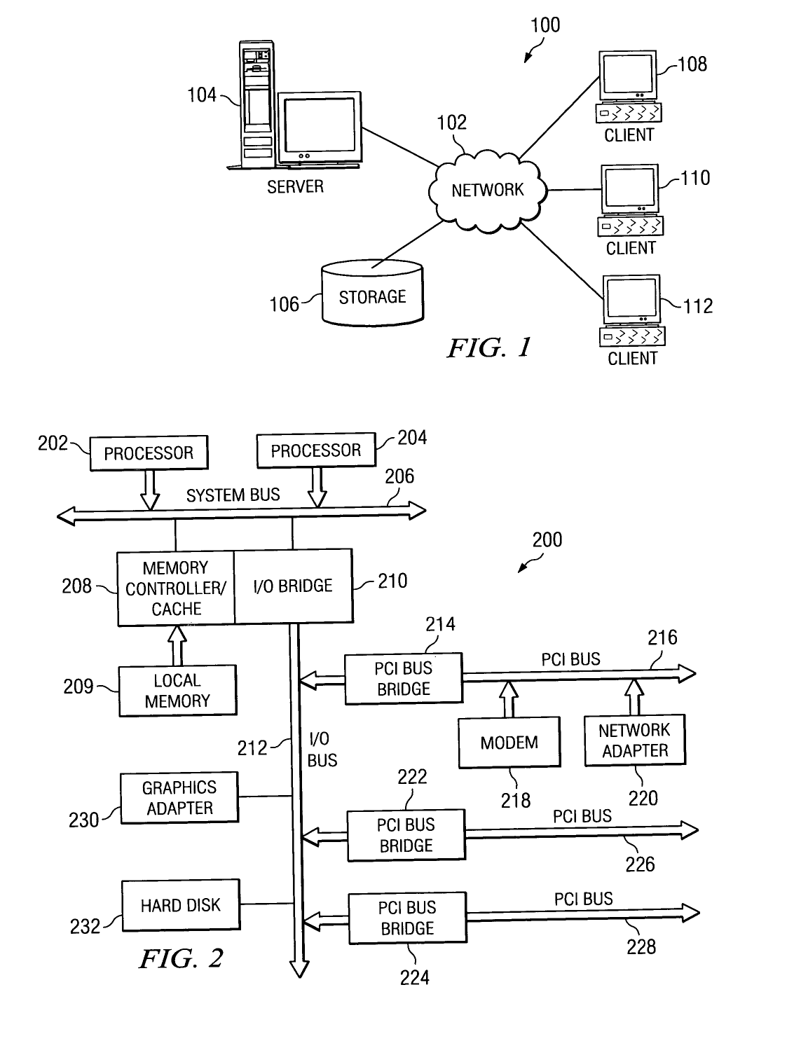

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

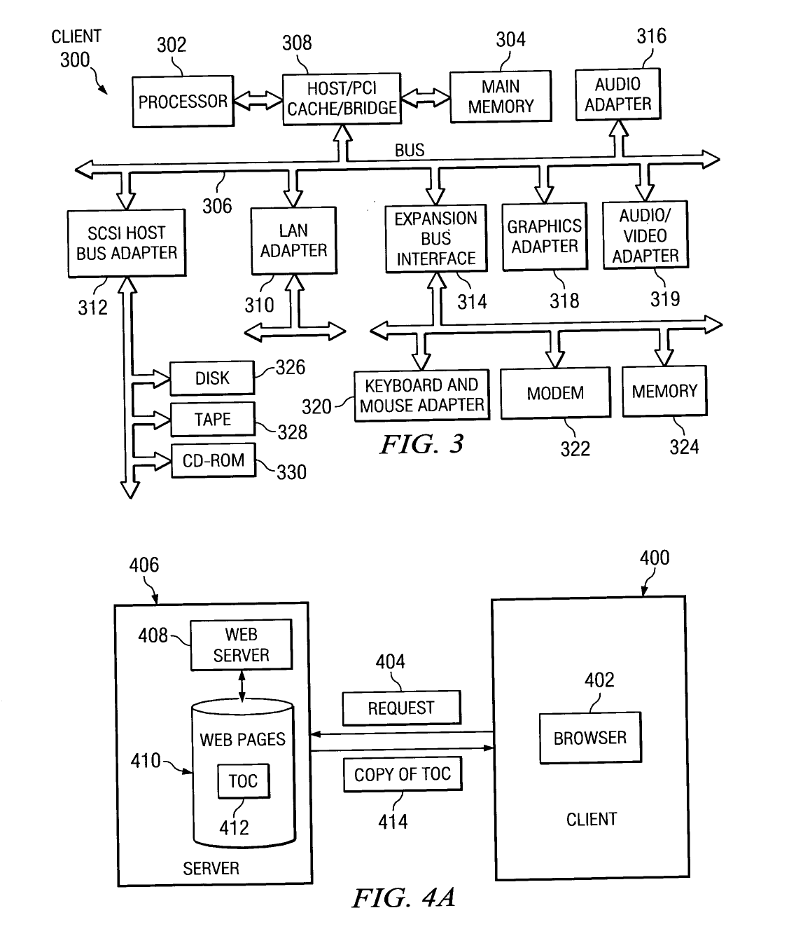

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for searching universal resource identifiers (URIs) using regular expressions, such as a string. A regular expression is a programming construct used to match patterns in textual data. The syntax varies from programming language to programming language. For example, a construct may be used to match all lines of a file that begin with the word “The” and end with a digit, by something like “\hat{ }The*[0-9]$”, where the \hat{ } means begin with, the * means whatever in the middle, the [0-9] means any number from 0-9 and the $ means to end with. The search mechanism in the illustrative examples of the present invention are especially useful for users familiar with a Web site. This mechanism does not require the Web site to be part of a search engine or provide keywords for the content. Further, the mechanism does not require the Web site to be publicly accessible.

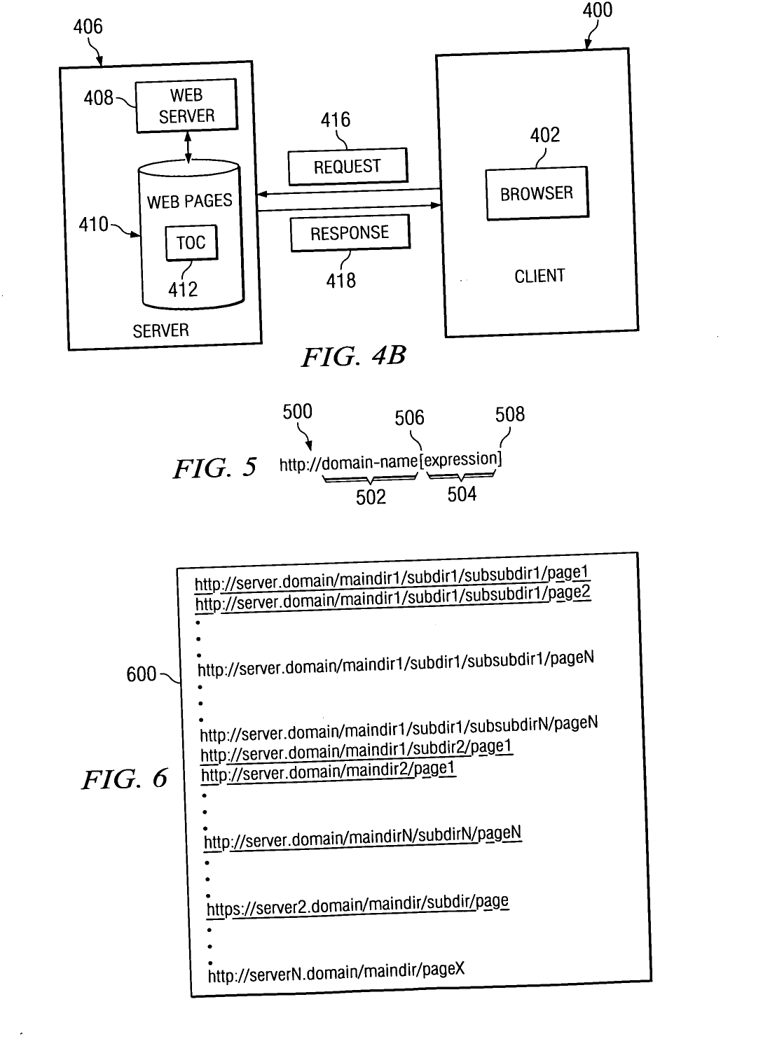

Turning now to FIGS. 4A and 4B, diagrams illustrating components used in providing a URI search system is depicted in accordance with a preferred embodiment of the present invention. In this example, client 400 contains browser 402. A user at client 400 may initiate a search using the mechanism of the present invention. In these examples, the domain name and a search expression using a regular expression is employed to generate request 404, which is sent to server 406. Server 406 contains Web server 408 with Web pages 410. Additionally, table of contents (TOC) 412 is contained with Web pages 410. Table of contents 412 is a page containing all of the Web site contents of the Web site in a URI format, such as universal resource locators (URLs).

Upon entry of the domain name with the regular expression, browser 402 recognizes that this combination as a command to initiate the search using the mechanism of the present invention. In response, browser 402 sends a request to server 406 to retrieve table of contents 412 which is returned as copy of table of contents 414. The request to retrieve copy of table of contents 414 requires the server to include a functional process that recognizes this request to return copy of table of contents 414.

Upon retrieving copy of table of contents 414 from Web server 408, a search is launched using the regular expression within copy of table of contents 414. In the search, the expression is used as a search term to determine whether this term is present within the URIs in copy of table of contents 414. For example, the search may be as follows: http:\\www.abc.com[tool expense]. The following URL in a table of contents would be considered a match: https:\\www-1.abc.com\tools\view\expenses\index.shtml. As can be seen, the term tool and expense are found within this URI. As described above, these matches are with respect to the URIs and not to content in the Web page itself. Additionally, another regular expression may be found within the delimiter. For example, another regular expression may be as follows: other types of delimiters may be used: [*expense*html$] which means any URI that has the text “expense” within it and ends with html.

Matches are displayed by browser 402 in a Web page using a link format in the illustrative examples. This link format allows a user to select one of the URIs and retrieve the Web page identified by the URI. In these examples, the URI takes the form of a universal resource locator. The different matches may be selected by the user to retrieve those pages from Web server 408.

In FIG. 4B, browser 402 generates request 416. In this case, request 416 contains the domain name and a regular expression as entered by the user at client 400 into browser 402. These two elements are separated by a delimiter. In response to receiving request 404, Web server 408 examines request 404. Web server 408 identifies the regular search expression, which in these examples is separated from the domain name by a delimiter. This delimiter is, for example, an open bracket and a closed bracket surrounding the regular expression to be searched. Other delimiters may be used, such as, for example, a “$” separating the domain name and the search expression. In these examples, the regular expression is used to retrieve the URIs that match the search pattern.

Web server 408 performs a search of table of contents 412 for matches using the regular expression. These matches are placed into a Web page and returned as response 418 for display by browser 402. In this case, the search occurs entirely on server 406. Only the results are returned and displayed by Web browser 402.

With reference to FIG. 5, an example of a command or request is depicted in accordance with a preferred embodiment of the present invention. In this example, request 500 forms a command that is recognized by the mechanism of the present invention for identifying URIs. In this example, request 500 includes domain name 502 and expression 504. In these examples, expression 504 is a regular expression. Expression 504 is separated from domain name 502 by a delimiter, which is formed by bracket 506 and 508 in the illustrative examples. Of course, any delimiter may be used depending on the particular implementation. For example, a “$” may be used as a delimiter to separate the regular expression from the domain name in place of the open and close bracket.

Turning now to FIG. 6, a diagram of a table of contents is depicted in accordance with a preferred embodiment of the present invention. Table of contents 600 is an example of a table of contents page, such as table of contents 412 in FIGS. 4A and 4B. This page contains a list of URIs for all of the different Web pages that are present on the Web site. The regular expression is used to search for matches within table of contents 600.

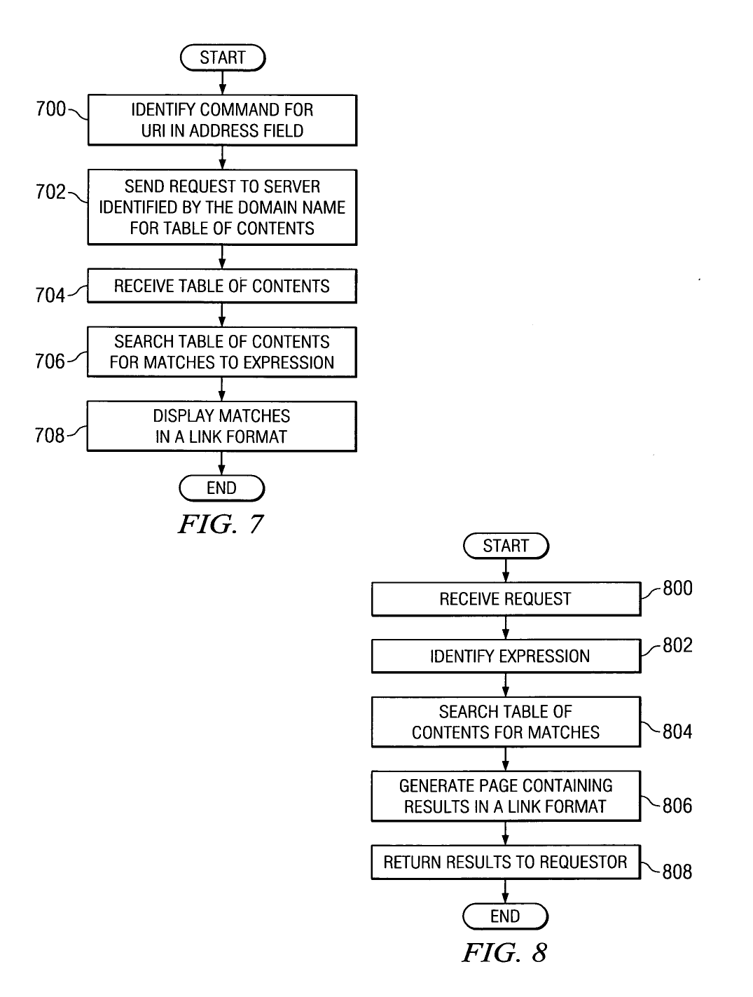

Turning next to FIG. 7, a flowchart of a process for searching for Web pages is depicted in accordance with a preferred embodiment of the present invention. The process illustrated in FIG. 7 may be implemented by a client side process, such as browser 402 in FIG. 4A and FIG. 4B.

The process begins by identifying a command in the URI address field (step 700). In these examples, the presence of a regular expression separated from a domain name by a delimiter may be used to indicate that a command to search URIs has been entered by the user. A request is sent to the server identified by the domain name for a table of contents (step 702). Step 702 requires implementing a command or process on the server side to return the table of contents to the requester. The table of contents is received (step 704).

Thereafter, a search of the table of contents is made to identify matches for the expression in the command received from the user (step 706). Matches to the expression are displayed in a link format (step 708) with the process terminating thereafter.

With reference now to FIG. 8, a flowchart of a process for processing a request to search for URIs is depicted in accordance with a preferred embodiment of the present invention. The process illustrated in FIG. 8 may be implemented in a server process, such as Web server 408 in FIG. 4A and FIG. 4B.

The process begins by receiving a request to search for URIs (step 800). The expression in the request is identified (step 802). The expression to be searched may be identified by searching for a delimiter, such as an open bracket and a close bracket. This expression is used to search a table of contents for matches (step 804). In these examples, the table of contents contains a set of URIs identifying Web pages located in the Web site. A page containing results is generated in which the page is in a link format (step 806). This link format allows a user to select a link and retrieve the page associated with the link. Thereafter, the results are returned to the requestor (step 808) with the process terminating thereafter.

Thus, in this manner, the present invention provides an improved method, apparatus, and computer instructions for searching for content on a Web site. The mechanism of the present invention allows a user to enter a domain name and a regular expression. In these examples, the domain name is separated from the expression through the use of a delimiter. Upon recognizing the domain name and expression as a command to search for URIs, the mechanism of the present invention identifies a table of contents for the Web site and searches the table of contents for URIs matching the expression in the request.

The results of matches to the expression are formatted into a Web page in a link format. This page is then displayed to the user. At this point, the user may select a link to retrieve the page associated with the link. In this manner, the number of steps needed to enter a Web site and perform a search are reduced. Further, the mechanism of the present invention allows for the searching to be performed either on the server side or client side.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for searching for Web pages within a Web site, the method comprising:
receiving a search statement as a result of a user input, wherein the search statement includes a universal resource identifier and a regular expression;
retrieving universal resource identifiers associated with the universal resource identifier in the request to form retrieved universal resource identifiers;
parsing the retrieved universal resource identifiers for the regular expression to form search results; and
returning the search results, wherein the search results include a list of universal resource identifiers associated with the Web pages within the Web site.

2. The method of claim 1, wherein the search results are returned as a Web page, wherein the universal resource identifiers are presented as a set of links, wherein selection of a link within the set of links causes a Web page identified by the link to be retrieved.

3. The method of claim 1, wherein the regular expression is separated from the universal resource identifier by a delimiter.

4. The method of claim 1, wherein the universal resource identifier is a domain name.

5. The method of claim 1, wherein the parsing step includes:
searching a table of contents for a match to the regular expression, wherein the table of contents contains the retrieved universal resource identifiers.

6. The method of claim 1, wherein retrieving, parsing, and returning steps are performed by a server hosting a Web site identified by the universal identifier, a proxy server, or a client at which the user input was entered.

7. A data processing system for searching for Web pages within a Web site, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a search statement as a result of a user input in which the search statement includes a universal resource identifier and a regular expression; retrieve universal resource identifiers associated with the universal resource identifier in the request to form retrieved universal resource identifiers; parse the retrieved universal resource identifiers for the regular expression to form search results; and return the search results in which the search results include a list of universal resource identifiers associated with the Web pages within the Web site.

8. A data processing system to search for Web pages within a Web site, the data processing system comprising:
receiving means for receiving a search statement as a result of a user input, wherein the search statement includes a universal resource identifier and a regular expression;
retrieving means for retrieving universal resource identifiers associated with the universal resource identifier in the request to form retrieved universal resource identifiers;
parsing means for parsing the retrieved universal resource identifiers for the regular expression to form search results; and
returning means for returning the search results, wherein the search results include a list of universal resource identifiers associated with the Web pages within the Web site.

9. The data processing system of claim 8, wherein the search results are returned as a Web page, wherein the universal resource identifiers are presented as a set of links, wherein selection of a link within the set of links causes a Web page identified by the link to be retrieved.

10. The data processing system of claim 8, wherein the regular expression is separated from the universal resource identifier by a delimiter.

11. The data processing system of claim 8, wherein the universal resource identifier is a domain name.

12. The data processing system of claim 8, wherein the parsing means includes:
searching means for searching a table of contents for a match to the regular expression, wherein the table of contents contains the retrieved universal resource identifiers.

13. The data processing system of claim 8, wherein retrieving, parsing, and returning means are performed by a server hosting a Web site identified by the universal identifier, a proxy server, or a client at which the user input was entered.

14. A computer program product in a computer readable medium for searching for Web pages within a Web site, the computer program product comprising:
first instructions for receiving a search statement as a result of a user input, wherein the search statement includes a universal resource identifier and a regular expression;
second instructions for retrieving universal resource identifiers associated with the universal resource identifier in the request to form retrieved universal resource identifiers;
third instructions for parsing the retrieved Web pages for the regular expression to form search results; and
fourth instructions for returning the search results, wherein the search results include a list of universal resource identifiers associated with the Web pages within the Web site.
